(19) United States
(12) Patent Application Publication
(10) Pub. No.: US 2010/0175118 A1
(43) Pub. Date: Jul. 8, 2010

(54) ACCESS TO SERVICE

(75) Inventor: Kjell Backlund, Jorvas (FI)

Correspondence Address: ZIEGLER IP LAW GROUP, LLC., 518 RIVERSIDE AVENUE, BUILDING B (Synergy), WESTPORT, CT, 06880, US

(73) Assignee: EMILLION OY, Helsinki (FI)

(21) Appl. No.: 12/601,456

(22) PCT Filed: May 23, 2008
(86) PCT No.: PCT/FI2008/050298

§ 371 Date: Nov. 23, 2009

(30) Foreign Application Priority Data
May 23, 2007 (FI) 20075371
Sep. 3, 2007 (FI) 20075603

(51) Int. Cl. H04L 29/06; H04L 9/32

(52) U.S. Cl. 726/8

(57) ABSTRACT

A method is described for providing access to service in an access management system accessible via a data network, in which data network a user is registered and/or authenticated to a service by providing at least one detail related to the user. A user is provided with an option to add a direct view to the service from an external micro application platform and allowed to select the option of adding the direct view and responsively negotiating with the external micro application platform credential information in order to form a trusted relationship for accessing the direct view from the external micro application platform. After recognizing of a show view request from the external micro application platform based on the trusted relationship, the external micro application platform is provided with the view to the service. Corresponding method in a micro platform is described.

### FIELD OF THE INVENTION

The present invention generally relates to providing access to a service. The invention relates particularly, but not exclusively, to enhancing the access management of the service to be able to provide direct and authenticated access from micro applications running on a micro application platform in another portal, on the desktop of a workstation or on a mobile device.

### BACKGROUND OF THE INVENTION

Recent development of Internet and World Wide Web has brought a new kind of micro applications that combines locally stored preferences and functionality with content and services available on the Internet. With this kind of functionality, users can easily monitor several sources of information without having to browse to all of them. Examples of such technologies are Google® Gadgets, Microsoft Windows® Live Gadgets and Symbian® Series 60 widgets.

However, important content, especially in business use, often requires a user to authenticate before the content is provided. Requiring users to enter credentials to each and every one of these micro applications would, however, destroy or at least severely damage the usability of the micro applications and the user experience.

It is an object of the invention to avoid or at least mitigate problems associated with prior art.

### SUMMARY

It has been understood by the inventor that a mechanism is needed to easily add a view from micro applications to different services or content in external services requiring user authentication.

According to a first aspect of the invention there is provided a method for providing access to a service in an access management system accessible via a data network according to appended claim 1.

Advantageously, the method enables providing a user with a micro application that becomes capable of showing a view to desired content possibly within an authenticated and/or registered session. The method also enables the user to simply use the authenticated/registered session to further use the service.

Different embodiments of the first aspect are presented in different dependent claims of claim 1. The content of these embodiments and also other embodiments is to be understood as possible to combine as suitably adapted to also other aspects of the invention, out of which:
a second aspect of the invention relates to a system according to the appended claim 12;
a third aspect of the invention relates to a computer program for causing a computer to perform when executed by a computer a method of the first aspect according to the appended claim 14;
a fourth aspect of the invention relates to a method in a micro application platform according to the appended claim 16; and
a fifth aspect of the invention relates to a computer program for causing a computer to perform when executed by a computer a method of the first aspect according to the appended claim 21.

### BRIEF DESCRIPTION OF THE DRAWINGS

The invention will be described, by way of example only, with reference to the accompanying drawings, in which:

FIG. 1 shows a schematic picture of main signaling in a system according to an embodiment of the invention;

FIG. 2 shows a further detail of the signaling of FIG. 1;

FIG. 3 shows a schematic drawing of a system according to an embodiment of the invention; and

FIG. 4 shows a signaling chart that demonstrates some typical signaling according to an embodiment of the invention;

### DETAILED DESCRIPTION

In the following description, like numbers denote like elements.

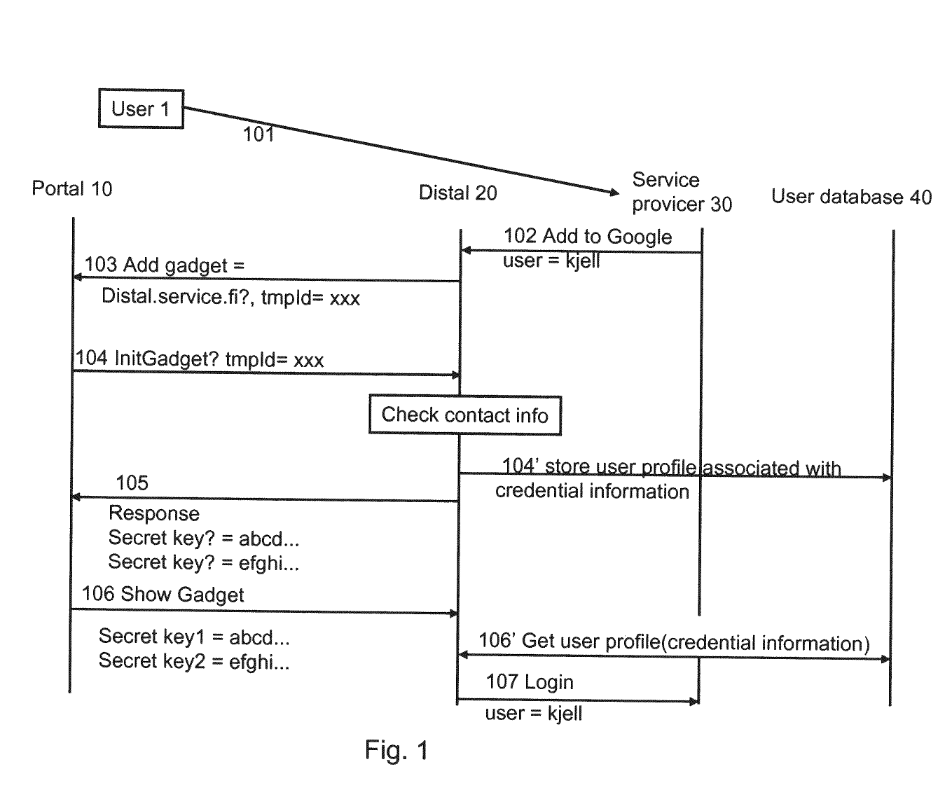

FIG. 1 shows a schematic picture of main signaling in a system according to an embodiment of the invention. The system comprises a portal that is here a Google® portal 10, an access management system 20 or distal in short that may be based on one or more servers, and a service providing system 30 that is a typical data providing service such as a phone number finder or music store.

At start, a user registers or authenticates 101 to a service provided by the service providing system 30. Next, the user is shown a link or button “add to Google” clicking which the user causes the service providing system to send a message 102 for adding to Google the user “Kjell” in this example. Next, the distal 20 sends 103 to the portal 10 a view insertion or micro application insertion directive with one-time usable contact information that contains an address in the distal and possibly in the address or in addition a unique code. The distal 20 also invokes a browser session at the user to the portal 10 so that on opening the portal page, the browser with its cookies initiates the gadget or micro application to the service and possibly asks for a confirmation from the user (not shown). If the user confirms proceeding or if not prompt to the user is provided, the portal 10 next sends a gadget initiation message or request 104 to the distal 20 with the one time contact information before the expiry thereof. The distal 20 checks the correctness of the contact information and if the contact information passes the check, the distal 20 provides the portal 10 with credential information using which the portal may access the service and obtain content into the portal 10. The distal 20 also stores 104′, typically into a user database 40, details related to the user profile and the credential information for subsequent use. The portal 10 may then obtain content to the added gadget by sending a show gadget request 106 with the credential information to the distal 20. Responsive to the gadget request 106, the distal typically fetches 106 the user profile associated with the credential information from the user database 40. Then the distal 20 logs the user into the service based on information in the profile of the user.

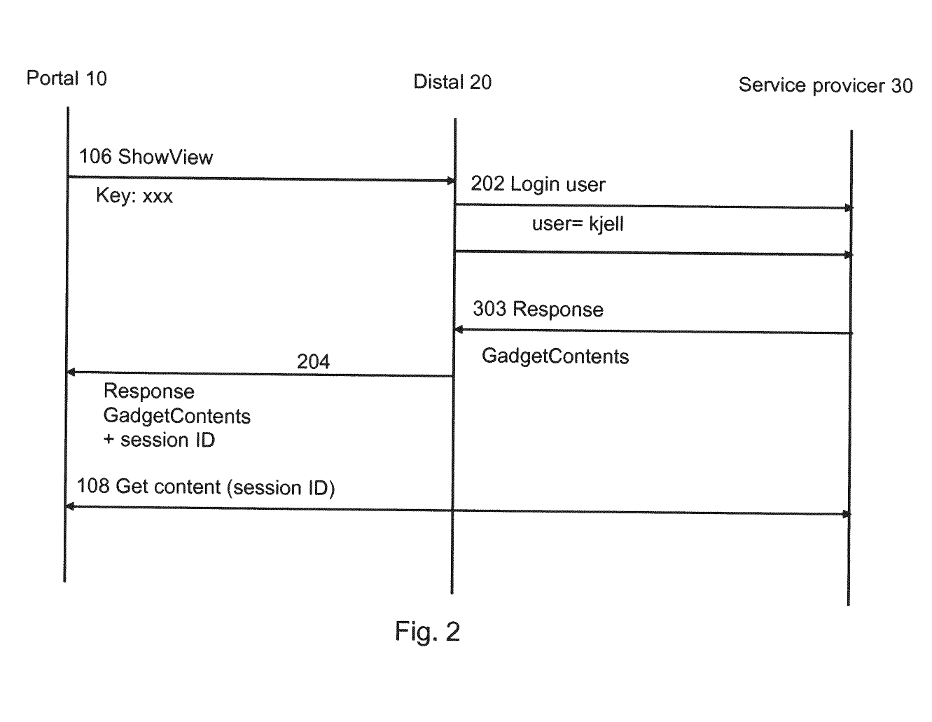

FIG. 2 shows further details on possible implementation of FIG. 1 at obtaining the content. The show view request 106 may be followed by a login message 202 from the distal 20 to the service provider 30 and other signaling between the distal 20 and the service provider 30 and then a response 203 from the service provider 30 to the distal 20. The distal may then forward a response 204 to the portal with gadget contents and session ID using which the portal 10 may directly access the service provider 30 to get the content as illustrated by signal 108.

It is understood that whilst FIGS. 1 and 2 show the portal 10 as a source of messages from the gadget, it is the gadget that causes the portal to form and send signals such as the gadget initialization 104 and show gadget request 106.

To explain some embodiments of the invention let us assume that the service provider is a video rental company providing video rental service. The service provider may allow the user to access extranet pages or generally a browser application (for instance, web pages are provided by an application at a web server). In the web page of the exemplary video rental service, three different links are provided for respective adding a gadget to Google® portal, adding a live gadget onto a Microsoft Windows Vista® desktop or adding a mobile widget to a widget enabled mobile device such as a modern Nokia® Series 60 mobile phone. The gadgets and widgets are in this document commonly denoted as x-dgets or micro applications. The micro applications are simple and light files which typically contain some definitions and processing code such as Java script to be interpreted by an x-dget platform or micro application platform. The micro application platform is, in case of Google® gadgets, a server that provides Google's user portal into which the users may add gadgets. For instance, with a gadget, a user may view a localized weather report or user selected share prices or trends so that the user selected customization appears together with normal Google® content such as a search box.

Using micro applications may enable the user to quickly and easily access desired services which require authentication as each micro application stores authentication data of a service thereby allowing signing on to the service. Advantageously, in an embodiment of the invention, the micro application may be configured into the micro application platform simply by activating a corresponding link when using a desired service. This may be implemented by clicking a respective link.

To add a micro application to the micro application platform, the platform may prompt the user to confirm the addition. The prompting may involve warning the client that external content is being provided through the micro application and that the service provider of the micro application may obtain some definitions of the user's preferences and other information.

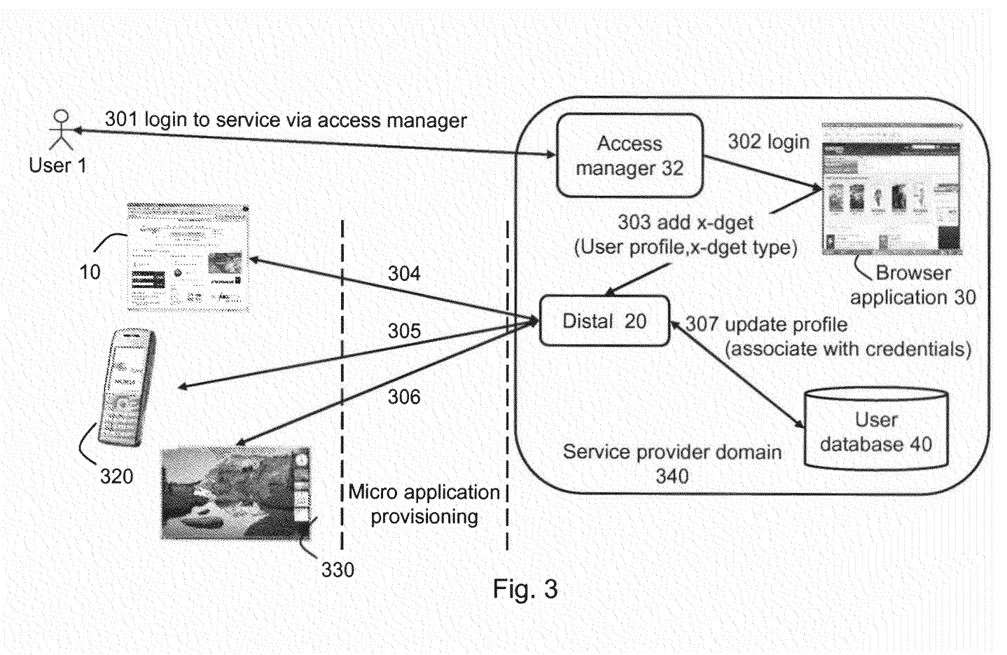

FIG. 3 illustrates an embodiment of the invention in which the service provider has a browser application (such as a web site) available for users. FIG. 3 shows some entities drawn into a common service provider domain 340, including a browser application 30′, a user database 40, a micro application controller denoted as distal 20 and an access manager 32. The access manager 32 and the browser application are configured to function as normal authentication server and service provider's browser application so that users may register and login to use the browser application 30. The browser application 30 differs from the function of the service provider 30 denoted in connection with FIGS. 1 and 2 in that in addition to providing an add to Google® functionality, the browser application 30 provides further functionalities of add to phone and add to desktop. FIG. 3 further shows for demonstration purpose the Google® portal 10, a mobile device 320 and a desktop 330. The desktop 330 may be, for instance, a Microsoft Windows Vista® desktop that is operable as a micro application platform (terms widget and gadget are commonly used). The mobile device 320 may be, for instance, a modern Series 60® mobile telephone that is operable as a micro application platform. The portal 10 is already described in the foregoing.

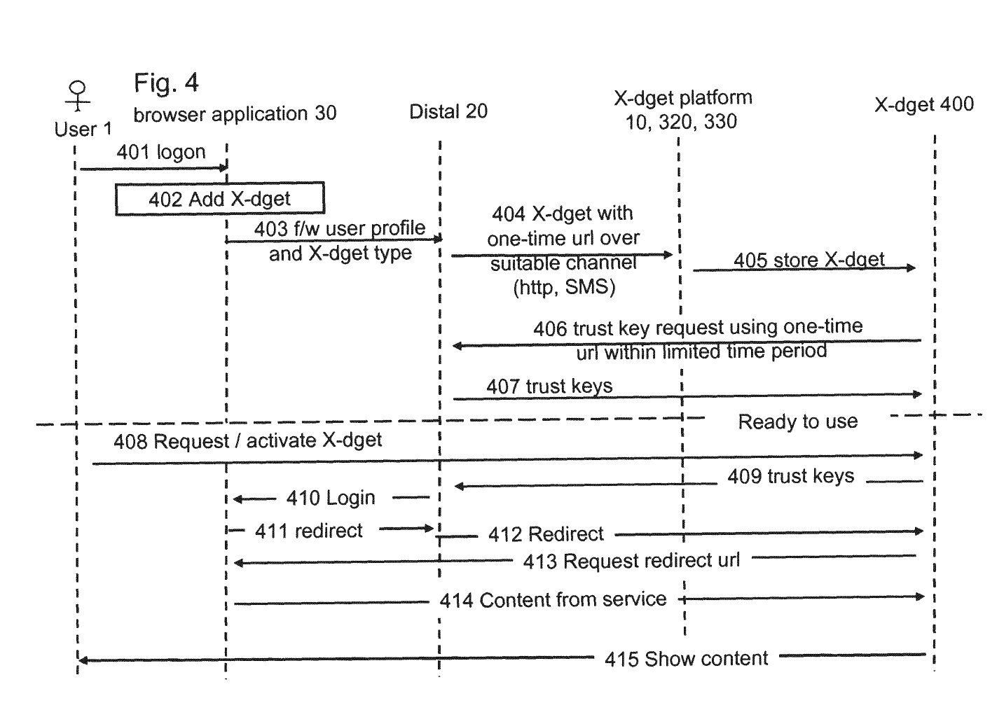

The user 1 may, at a desired time, login 301 to the service provided by the browser application 30 by accessing a URL associated with the browser application 30, for instance. The access manager 32 typically prompts for a user name and password, which the user gives in order to access the content provided by the browser application (which may involve also or alternatively feeding in content by the user). When signed on to use the service, the user may choose to add a suitable micro application to her chosen micro application platform by activating an associated function with the browser application 30. For instance, if the user desires to add a widget to her computer desktop 330, she may activate a corresponding function. In response to indicating to the browser application 330 that a micro application should be added to the user's chosen platform, the browser application 330 sends 303 an add x-dget (add micro application) command to the distal 20. The add x-dget command includes at least one detail related to the profile of the user logged on to the browser application. In any case, once armed with the add x-dget command, the distal 20 communicates 304, 305, 306 or performs micro application provisioning with the user's micro application platform 10, 320, 330 that is indicated by the add x-dget command 303. The micro application provisioning is, in case of the portal 10, identical to that described in the foregoing in connection with FIGS. 1 and 2. In case that the chosen micro application platform is the mobile device 320, the signaling is similar to that with the portal 10, but the signaling may employ short message service (SMS) or multimedia message service (MMS) alternative to the commonly usable internet communications such as hyper text transport protocol (HTTP), secure HTTP (HTTPS), e-mail and instant messaging. Basically, the distal 20 communicates the micro application (gadget or widget) over a suitable channel. As will be described in more detail in connection with FIG. 4, the provisioning of the micro application typically involves delivering a one-time universal resource locator (URL) for trust establishment with the micro application. The micro application then accesses the one-time URL and obtains within a set limited time period secret keys which the X-dget i.e. micro application stores for later obtaining the trust keys needed to access the service without the user's manual interaction. The x-dget then obtains the trust keys and stores the trust keys at the user's micro application platform. The distal 20 also updates the user database 40 so that the trust keys are associated with the user's profile as is illustrated with more detail in the following.

FIG. 4 illustrates a signaling chart that demonstrates some typical signaling according to an embodiment of the invention. The user 1 first logs on to the web application as normal via the access manager 32 (not shown in FIG. 4 in sake of simplicity). When using the service, the user activates 402 the add micro application function for a given platform. The browser application 30 responsively forwards 403 the user profile and platform indication to the distal 20. The distal 20 then sends 404 a micro application 400 and a particular one-time identifier such as a URL over a channel suitable for the given platform, based on the data in the user profile (e.g. mobile phone number for sending a short message). The given micro application platform (portal 10, mobile device 320 or desktop 330) receives the micro application. The platform stores 405 the micro application (i.e. x-dget in FIG. 4) that contains necessary instructions for causing the platform to request 406 for trust key or keys using the one-time identifier within a limited period during which the one-time identifier is held valid by the distal 20. If the distal 20 receives the trust key request in time, it replies by sending 407 the trust keys to the micro application 400. Armed with the trust keys, the micro application is now capable of using the service for the user as is next explained.

The trust keys do not preferably contain the login data of the user to the browser application. If they did, the trust keys would not work after any change to the password of the service and the user should renew the micro application into each platform the user likes to use. Hence, to obtain content, the micro application will not access the browser application directly but via the distal 20. When the user so desires, she activates the micro application by a signal 408 to the micro application 400, which responsively sends 409 the trust keys to the distal 20. The distal 20 obtains from user database 40 the user's profile or at least the user's logon particulars and performs login 410 to the browser application 30 with a redirection instruction. The browser application 30 replies 411 with a redirection address which the distal 20 then sends to the micro application 400. The micro application then accesses 413 the redirection address and responsively receives 414 content from the service and then presents 415 received content to the user 1.

The trust keys may form external micro application platform credential information or be used in producing the external micro application platform credential information. The trust keys are typically a set of one or more secret keys used to confirm the authenticity of requests from the micro application. While in one embodiment of the invention the trust keys contain the actual login data of the user, it is yet preferred that the trust keys contain or use one or more random keys, which are meaningless in any other context than when communicating between a particular micro application and distal.

In this application, a user account for the service generally refers to a profile stored for use of the service. The profile may contain any of the user's physical address, e-mail address, name, phone number, password and user's preferences. The user account for the portal may likewise contain any of the user's physical address, e-mail address, name, phone number, password and user's preferences such as definition of different gadgets, portlets and any views to be presented within the portal.

The foregoing description has provided by way of non-limiting examples of particular implementations and embodiments of the invention a full and informative description of the best mode presently contemplated by the inventors for carrying out the invention. For example, the credential information may be used either as such or based on a derivative such as a hash result thereof; the content may be audio, video, or any other media or program content; and the credential information may be generally anything to prove the identity of the user to a sufficient extent. Hence, it is clear to a person skilled in the art that the invention is not restricted to details of the embodiments presented above, but that it can be implemented in other embodiments using equivalent means without deviating from the characteristics of the invention.

Furthermore, some of the features of the above-disclosed embodiments of this invention may be used to advantage without the corresponding use of other features. As such, the foregoing description shall be considered as merely illustrative of the principles of the present invention, and not in limitation thereof. Hence, the scope of the invention is only restricted by the appended patent claims.

1-19. (canceled)

20. A method for providing access to a service in an access management system accessible via a data network, in which data network a user is registered and/or authenticated to the service by providing at least one detail related to the user; the method comprising:
providing the user with an option to add a direct view to the service from an external micro application platform;
allowing the user to select the option of adding the direct view and responsively providing the micro application platform with a micro application in order to add the direct view to the service and negotiating with the micro application platform credential information in order to form a trusted relationship for accessing the direct view from the external micro application platform; and
recognizing a show view request from the external micro application based on the trusted relationship and responsively providing the external micro application platform with the view to the service.

21. The method of claim 20, wherein the negotiating comprises providing the micro application with one-time contact information related to a first user account of the user for the service and responsive to a request from the micro application using the one-time contact information, responding with the credential information to the micro application.

22. The method according to claim 21, wherein:
a) the one-time contact information has a predetermined validity term and the one time contact information is disqualified after the expiry of said validity term; and/or
b) the one-time contact information is disqualified after its first use.

23. The method according to claim 21, comprising maintaining at one time an association between the one-time contact information and the user and at a subsequent time an association between the credential information and the user.

24. A method according to claim 21, wherein the credential information is generated on receiving the request from the micro application comprising the one-time contact information.

25. A method according to claim 21, wherein the contact information comprises an address for sending the request and optionally a unique code included in the address.

26. The method according to claim 20, wherein responsive to the selecting of the option, the browser of the user is directed by the access management system to the micro application.

27. The method according to claim 26, wherein the user is prompted for acceptance for adding the direct view from the external micro application platform before completing the negotiating.

28. The method according to claim 20, wherein on recognizing a show view request from the micro application based on the trusted relationship, the access management system authenticates the user to the service, establishes a session in the service and obtains content requested by the show view request and then provides the micro application with the view to the service.

29. The method according to claim 20, wherein the micro application platform is selected from a group consisting of a portal, a computer desktop and a mobile device.

30. An access management system for providing access to a service which system is accessible to users via a data network, in which data network a user is registered and/or authenticated to the service by providing at least one detail related to the user; the system comprising:
means for providing the user with an option to add a direct view to the service from an external micro application platform;
means for allowing the user to select the option of adding the direct view and responsively providing the micro application platform with a micro application in order to add the direct view to the service and negotiating with the micro application credential information in order to form a trusted relationship for accessing the direct view from the external micro application platform; and
means for recognizing a show view request from the micro application based on the trusted relationship and responsively providing the external micro application platform with the view to the service.

31. An access management system according to claim 30, wherein the negotiating comprises providing the micro application with one-time contact information related to a first user account of the user for the service and responsive to a request from the micro application using the one-time contact information, responding with the credential information to the micro application.

32. An access management system according to claim 30, wherein the system further configured to cause directing, responsive to the selecting of the option, the browser of the user to the micro application.

33. A computer program embodied in a computer readable medium for controlling an access management system to provide access to a service, which system is accessible to users via a data network, in which data network a user is registered and/or authenticated to the service by providing at least one detail related to the user; the program comprising:
computer executable program code for enabling the system to provide the user with an option to add a direct view to the service from an external micro application platform;
computer executable program code for enabling the system to allow the user to select the option of adding the direct view and responsively providing the micro application platform with a micro application in order to add the direct view to the service and negotiating with the micro application credential information in order to form a trusted relationship for accessing the direct view from the external micro application platform; and
computer executable program code for enabling the system to recognize a show view request from the micro application based on the trusted relationship and responsively providing the external micro application platform with the view to the service.

34. A computer program according to claim 33, wherein the negotiating comprises providing the micro application with one-time contact information related to a first user account of the user for the service and the computer program further comprises computer executable program code for enabling the system, responsive to a request from the micro application using the one-time contact information, to respond with the credential information to the micro application.

35. A method for accessing an external service in a micro application platform, comprising:
receiving from an external access management system a view insertion directive for a view to the external service, the directive comprising a micro application and a one-time contact information and being related to a first user account of the external service which first user account is unidentified to the micro application platform in the directive;
associating the directive with a second user account that is a user account of the micro application platform;
causing by the micro application sending of a credential request using the one-time contact information to the external access management system;
responsive to the credential request, receiving credential information from the external access management system; and
causing by the micro application storing of the credential information as part of preferences associated to the second user account and the view to the external service.

36. The method according to claim 35, further comprising sending by the micro application a show view request based on the credential information.

37. The method according to claim 35, further comprising receiving by the micro application content corresponding to the show view request and presenting the content in the view to the service within the micro application platform.

38. The method according to claim 35, wherein the micro application platform is selected from a group consisting of a portal, a computer desktop and a mobile device.

39. A computer program embodied in a computer readable medium configured to cause a computer on execution to:
receive from an external access management system a view insertion directive for a view to the external service, the directive comprising a micro application and a one-time contact information and being related to a first user account of the external service which first user account is unidentified to the micro application platform in the directive;
associate the directive with a second user account that is a user account of the micro application platform;
cause by the micro application sending of a credential request using the one-time contact information to the external access management system;
responsive to the credential request, receive credential information from the external access management system; and
cause by the micro application storing of the credential information as part of preferences associated to the second user account and the view to the external service.
